(19) United States
(12) Patent Application Publication
(10) Pub. No.: US 2008/0290269 A1
(43) Pub. Date: Nov. 27, 2008

(54) Time-Of-Flight Mass Spectrometer

(76) Inventors: Naoaki Saito, Tsukuba-shi (JP); Masataka Ohkubo, Tsukuba-shi (JP); Kazuyoshi Koyama, Tsukuba-shi (JP); Eisuke Miura, Tsukuba-shi (JP)

Correspondence Address: OSTROLENK FABER GERB & SOFFEN, 1180 AVENUE OF THE AMERICAS, NEW YORK, NY, 100368403, US

(21) Appl. No.: 11/908,758

(22) PCT Filed: Jan. 25, 2006
(86) PCT No.: PCT/JP2006/301150

§ 371 Date: Sep. 14, 2007

(30) Foreign Application Priority Data
Mar. 17, 2005 (JP) 2005-077055

(51) Int. Cl. H01J 49/40

(52) U.S. Cl. 250/287

(57) ABSTRACT

A time-of-flight mass spectrometer comprising an accelerating portion that includes a repeller electrode and an extractor electrode, in which an inner surface on the extractor electrode side of the repeller electrode has a curved shape, the extractor electrode is a flat plate with a hole in the center or a plate structure including a mesh structure, and the accelerating portion converges a distribution of times of flight accompanying deviations in the acceleration start position of ions and also performs trajectory control by correcting a distribution of the introduction energy of ions. In accordance with the above-described structure, it is possible to realize both functions of a conventional accelerating portion and ion lens system with only an accelerating portion and it is possible to simplify and reduce the size of the time-of-flight mass spectrometer.

### TECHNICAL FIELD

The present invention relates to a mass spectrometer that analyses the mass of particles and ions, and particularly relates to a time-of-flight mass spectrometer.

### BACKGROUND ART

A conventional time-of-flight mass spectrometer accelerates ions by an electric field in an accelerating portion and then, by making the ions fly a certain distance, measures the time of flight until they reach a detector. Since the time of flight is proportional to the ratio of mass to electrical charge, it is possible to determine the mass from measurement of the time of flight. Note that in some cases an electric field lens or reflecting electric field (reflector) or the like is disposed in the path from the accelerating portion to the detector.

The ion accelerating portion that is used in conventional time-of-flight mass spectrometers is constituted by a repeller electrode of a flat plate or of a plate structure including a mesh structure, and a extractor electrode of a flat plate with a hole in the center or of a plate structure including a mesh structure, with these electrodes installed in a parallel manner. Also, in addition to these electrodes, there are also cases of installing a plurality of electrodes. By applying different electric potentials to these electrodes, ions are accelerated by the electric fields generated between the electrodes (for example, refer to Patent Document 1).

FIG. 2 and FIG. 3 are conceptual drawings showing cross sections of conventional time-of-flight mass spectrometers. FIG. 2 is a conceptual drawing of a linear-type time-of-flight mass spectrometer (in the case of being constituted from a two-stage accelerating portion, lens system and detector), and FIG. 3 is a conceptual drawing of a reflector-type time-of-flight mass spectrometer (in the case of being constituted from a single-stage accelerating portion, lens system and detector). The structure and action of the conventional time-of-flight mass spectrometers shall be explained assuming the case of the potential of the extractor electrode being zero, that is, at ground potential, and a predetermined voltage being applied to the repeller electrode, in order to simplify the description. In FIG. 2 and FIG. 3, reference numeral 11 denotes a neutral particle or an ion that is introduced, reference numeral 12 denotes a repeller electrode, reference numeral 13 denotes an intermediate electrode, reference numeral 14 denotes a ground electrode, reference numeral 15 denotes a lens system, reference numeral 16 denotes a detector, reference numeral 17 denotes a extractor electrode, and reference numeral 18 denotes a reflector.

In the case of the object of analysis being a neutral particle, the voltage that is applied to the repeller electrode 12 may be a steady voltage. In the case of FIG. 3, a method, in which a neutral particle is ionized by a laser pulse at a predetermined position (acceleration start position) between the repeller electrode 12 and the extractor electrode 17, is adopted. The ion is accelerated by the electric field between the repeller electrode 12 and the extractor electrode 17.

In the case of the object of analysis being an ion, first the voltage of the repeller electrode 12 is set to zero. Then, a predetermined voltage is applied in steps to the repeller electrode 12 from the moment the ion reaches the aforementioned acceleration start position. In the case of FIG. 3, the ion is accelerated by the electric field between the repeller electrode 12 and the extractor electrode 17 from the moment that the voltage is applied to the repeller electrode 12.

Hereinbelow, in order to simplify the description, the case is explained of using a laser to ionize a neutral particle that is introduced from outside of the accelerating portion into a monovalent cation.

Since the acceleration start position in reality has a limited size without being a point, the ion flight distance and the kinetic energy that the ion obtains by being accelerated by the electric field have distributions. In order to obtain a high mass resolution by correcting the distribution, a Wiley-McLaren-type two-stage accelerating portion or reflecting electric field (reflector) or the like are employed.

A method of accelerating an ion perpendicularly to the direction of introduction to the accelerating portion is widely employed. Since the ion possesses introduction energy, by controlling the trajectory of the ion to guide it to the detector, the lens system 15 is required in the latter stage of the accelerating portion. As the lens system 15, an XY deflector lens, Einzel lens, or quadrupole lens is conventionally used. By applying a predetermined voltage to these lenses, an electric field is generated, whereby control of the ion trajectory is performed. Also, since there is in fact a distribution in the introduction energy, it is necessary to use a superior ion lens system.

Also, Patent Document 2 (Japanese Unexamined Patent Application, First Publication No. 2000-36282) discloses an art in which a push-out side electrode is a quadric surface or a cubic surface, and the lead-out side electrode has a pore or a pin hole, with an electric field being formed that converges ions that have spread out in an accelerating portion into the pore or the pin hole. However, since the ion trajectory spreads outs after passing through the pin hole in this art, a lens system is required to make the ions reach the detector. Also, the art disclosed in this publication has as its object to improve the detection accuracy by an increase in the ion intensity and to reduce noise, but correction of changes in trajectory by the introduction energy and improving the time convergence (mass resolution) which is critical for a spectrometer are not covered.

Also, Patent Document 3 (Japanese Unexamined Patent Application, First Publication No. S61-140047) discloses an electron impact ion source that has a tripolar construction being constituted from a thermionic cathode, an anode, and an ion extractor electrode, wherein the anode formed in a hemispherical shape, the hemispherical anode has a blocked shape by integrally joining a metal lattice or metal net to the discharge end edge of the hemispherical anode, the thermionic cathode is disposed on the outer circumference of the hemispherical side of the anode, and the ion extractor electrode is disposed on the cross-sectional side of the anode.

Also, Patent Document 4 (Japanese Unexamined Patent Application, First Publication No. H04-212254) discloses using an ion source for a quadrupole mass spectrometer that includes a first extractor electrode that has a spherical surface, a disc-shaped second coaxial electrode that has a central orifice with a comparatively large width, and a disc-shaped third electrode that has a comparatively small central orifice, being adjusted so as to form a hemispheric equipotential surface between the first electrode and the second electrode. Also, as disclosed in this publication, this art has electric field shape that converts an asymmetric ion beam that is introduced to the ion source to a beam that passes through the small disc-shaped orifice, and thereby improves the sensitivity by utilizing the large ionization volume that spreads throughout the entire ion source. For this reason, an optimal electrode shape and electric field shape are determined so as to efficiently drawn out ions that spreads throughout the entire ion source in the form of a beam.

Also, Patent Document 5 (U.S. Pat. No. 3,678,267) discloses an art relating to an ion source for efficiently drawing out gas ions that are ionized by an electron beam as an ion source comprising a concave-shaped repeller electrode. These ions are generated in an extraction gap (ionization space) between the extraction electrode and the repeller electrode with a concave-shaped inner wall. These ions are drawn out through the extraction electrode by electric fields produced by an accelerating electrode. The concave shape of the repeller electrode is hemispherical or cylindrical, and generates a potential in the ionization space so as to be able to efficiently extract ions regardless of the acceleration potential. That is, this ion source includes the three electrodes of the repeller electrode with a concave-shaped inner wall, the extraction electrode, and the accelerating electrode, and is characterized by generating an electric field that is capable of efficiently extracting ions.

### Patent Document 1: Japanese Unexamined Patent Application, First Publication No. 2003-346704

### Patent Document 2: Japanese Unexamined Patent Application, First Publication No. 2000-36282

Patent Document 3: Japanese Unexamined Patent Application, First Publication No. S61-140047
Patent Document 4: Japanese Unexamined Patent Application, First Publication No. H04-212254
Patent Document 5: U.S. Pat. No. 3,678,267

### DISCLOSURE OF THE INVENTION

### Problem to be Solved by the Invention

In conventional time-of-flight mass spectrometers, in order to obtain a high mass resolution by correcting the distribution of the acceleration starting point of ions, a Wiley-McLaren-type two-stage accelerating portion or reflecting electric field (reflector) or the like are employed. The Wiley-McLaren-type two-stage accelerating portion is constituted from three or more electrodes, and different voltages must be applied to these electrodes. Also, conventional time-of-flight mass spectrometers employ a method of accelerating ions perpendicularly to the direction of introduction, and for that reason a lens system that controls the trajectory of ions is required in the latter stage of the accelerating portion.

Moreover, in the conventional system, such a lens system is constituted from a plurality of electrodes, and different voltages must be applied to these electrodes. In order to simplify (and lower the price) of the spectrometer and reduce the size thereof, a new method that simplifies the accelerating portion and lens system is desired while maintaining high functionality.

Accordingly, the present invention has as its main object to simplify the accelerating portion in a time-of-flight mass spectrometer, and enable accurate mass spectrometry without using a lens system.

### Means for Solving The Problem

The inventors, as the result of concerted study directed towards eliminating these disadvantages, discovered that, with only two electrodes, namely, a repeller electrode having a curved shape and a extractor electrode of a flat plate having a hole in the center or of a plate structure including a mesh structure, (1) it is possible to realize the same effect as a conventional Wiley-McLaren-type two-stage accelerating portion for obtaining a high resolution, and (2) it is possible to realize both effects of a conventional accelerating portion and ion lens system that accelerate an ion and control the trajectory thereof. The present invention was made based on this discovery.

In other words, the time-of-flight mass spectrometer in accordance with the present invention includes an accelerating portion that includes a repeller electrode and a extractor electrode with a hole, in which an inner surface on the extractor electrode side of the repeller electrode has a curved shape, and the accelerating portion converges a distribution of times of flight accompanying deviations in the acceleration start position of ions and also performs trajectory control by correcting a distribution of the introduction energy of ions.

Also, another time-of-flight mass spectrometer in accordance with the present invention is characterized by the curved shape of the repeller electrode in the aforementioned time-of-flight mass spectrometer forming an approximate paraboloidal shape, an approximate hyperboloid shape, or an approximate hemispherical shape or the like.

Also, another time-of-flight mass spectrometer in accordance with the present invention includes an accelerating portion that includes a repeller electrode and a extractor electrode with a hole, in which the repeller electrode is constituted by a plurality of electrodes, and an equipotential surface in the vicinity of the repeller electrode has a curved shape, and the accelerating portion converges a distribution of time of flights accompanying deviations in the acceleration start position of ions and performs trajectory control by correcting a distribution of the introduction energy of ions.

Also, another time-of-flight mass spectrometer in accordance with the present invention is characterized by the curved shape of the equipotential surface of the repeller electrode in the aforementioned time-of-flight mass spectrometer forming an approximate paraboloid shape, an approximate hyperboloid shape, or an approximate hemispherical shape or the like.

Also, another time-of-flight mass spectrometer in accordance with the present invention is characterized by the extractor electrode with a hole in the aforementioned time-of-flight mass spectrometer being a flat plate with a hole that is circular, elliptical or oval, or polygonal such as rectangular or the like formed in the center.

Also, another time-of-flight mass spectrometer in accordance with the present invention is characterized by the extractor electrode with a hole in the aforementioned time-of-flight mass spectrometer being a mesh structure.

Also, another time-of-flight mass spectrometer in accordance with the present invention is characterized by providing a plurality of the extractor electrodes in the aforementioned time-of-flight mass spectrometer.

Also, another time-of-flight mass spectrometer in accordance with the present invention is characterized by forming an opening in the center of the repeller electrode on the side opposite the side at which the extractor electrode is arranged, disposing a sample holding base facing the opening, and discharging a particle that is held in the sample holding base by ionization via laser irradiation in the aforementioned time-of-flight mass spectrometer.

Also, another time-of-flight mass spectrometer in accordance with the present invention is characterized by guiding an ion discharged from the extractor electrode to a detector by reflecting with a reflector in the aforementioned time-of-flight mass spectrometer.

Also, another time-of-flight mass spectrometer in accordance with the present invention is characterized by introducing a neutral particle or an ion to be introduced to the repeller electrode, which is constituted by a plurality of electrodes, to the repeller electrode from a gap between the separated electrodes in the aforementioned time-of-flight mass spectrometer.

The present invention is constituted as described above. In the art of Patent Document 2, as disclosed in the same publication, the lead-out side electrode is a pore or pinhole, use of a mesh is inconvenient, and, moreover, the pore of the lead-out side electrode should be small and, moreover, the pore should be made still smaller into a pinhole. In contrast, the lead-out side electrode in the present invention is preferably of a shape of a mesh or a hole with a long axis. Moreover, in the art disclosed in the same publication, since the trajectory of an ion widens after the pinhole, in order to converge the ion beams onto the detector, a lens is required. In contrast, the present invention does not require a lens. On this point, the art of Patent Document 2 cannot achieve the action of the present invention.

Also, in the art of Patent Document 3, a portion of the shape of the anode is hemispherical, and so a portion that resembles the present invention exists. However, in this art, a metal lattice or metal net is joined to the discharge end edge of the hemispherical anode, so that the anode has a blocked shape, with the electric field in this blocked inner portion being constant. In contrast, the discharge end edge of the curved anode of the repeller electrode of the present invention is opened, and the electric field in the space that is surrounded by the repeller electrode is not constant and forms an equipotential surface that is capable of approximating a curved surface. Accordingly, this patent document discloses art in which the shape of the spatial electric field is greatly different from the present invention and the action imparted to an ion is completely different, and so cannot achieve the action of the present invention.

Also, in the art of Patent Document 4, as disclosed in the same publication, this art is characterized by being an electric field shape that converts an asymmetric ion beam that is introduced to the ion source to a beam that passes through the small disc-shape orifice, and thereby improves sensitivity by utilizing the large ionization volume that spreads throughout the entire ion source. Therefore, an optimal electrode shape and electric field shape need to be determined so as to efficiently draw out ions that spread throughout the entire ion source as a beam. Also, this means using an ion source for a quadrupole mass spectrometer, and is not one to be used as an ion source for a time-of-flight mass spectrometer or one used for an accelerating portion. Accordingly, the art of Patent Document 4 also cannot achieve the action of the present invention.

Also, the art of Patent Document 5 is art for efficiently utilizing ions that have greatly spread out in an ionization space. In order to form an electric field so as to be able to efficiently utilize these ions, the electrode shape and electrode interval and applied potential are adjusted. By performing mass spectrometry using ions that have greatly spread in the ion source, the mass resolution decreases. Therefore, this art greatly differs from the present invention by using only ions that exist near a certain point on the Z axis and not using ions that have greatly spread out in the ion source. Also, regarding ions that start from near a certain point on the Z axis, the present invention is characterized by forming an electric field so as to improve the mass resolution by making the trajectory of ions possessing introduction energy parallel to the Z axis and correcting the distribution of start positions to converge times of flight. In order to form the best electric field to attain this object, the electrode shape and electrode interval are adjusted. That is, the electrode shape is seemingly similar in the conventional art and the present invention, but the object ions and the target effect greatly differ. Similarly, the optimal electrode shape and electrode placement greatly differ between the conventional art and the present invention, and so the art of Patent Document 5 cannot achieve the action of the present invention.

### EFFECTS OF THE INVENTION

The present invention, by having the aforedescribed constitution, can realize both effects of a conventional accelerating portion and ion lens system with only a repeller electrode and an extractor electrode.

### BRIEF DESCRIPTION OF THE DRAWINGS

FIG. 1 is an explanatory drawing that shows a first embodiment of the accelerating portion in the time-of-flight mass spectrometer of the present invention.

FIG. 2 is a schematic drawing that shows an example of a conventional linear-type time-of-flight mass spectrometer.

FIG. 3 is a schematic drawing that shows an example of a conventional reflector-type time-of-flight mass spectrometer.

FIG. 4 is a schematic drawing of a time-of-flight mass spectrometer that has a conventional single-stage accelerating portion.

FIG. 5 is a schematic drawing of a time-of-flight mass spectrometer that has a Wiley-McLaren-type two-stage accelerator portion, shown with the potential distribution.

FIG. 6 is a schematic drawing of a time-of-flight mass spectrometer of the present invention, shown with the potential distribution.

FIG. 7 is a drawing showing the device dimensions and voltage for the case of the inner surface of the repeller electrode being a paraboloid.

FIG. 8 is a drawing that standardizes the device dimensions and voltage in the same drawing.

FIG. 9 is a graph that shows a simulation result of a specific example shown in the same drawing.

FIG. 10 is a drawing that shows one example of the calculation result of the electric field and ion trajectory of the accelerating portion in the time-of-flight mass spectrometer in accordance with the present invention in which the accelerating electrode is a paraboloid.

FIG. 11 is an explanatory drawing that shows an example of the electric field and ion trajectory of the accelerating portion for the time-of-flight mass spectrometer in the present invention in which the accelerating electrode is a hyperboloid.

FIG. 12 is an explanatory drawing that shows an example of the electric field and ion trajectory of the accelerating portion for the time-of-flight mass spectrometer in the present invention in which the accelerating electrode is a hemispherical.

FIG. 13 is an explanatory drawing that shows a separate example of the calculation result of the electric field and ion trajectory of the accelerating portion in the time-of-flight mass spectrometer in accordance with the present invention in which the accelerating electrode is a paraboloid.

FIG. 14 is a schematic drawing that shows an example of a linear-type time-of-flight mass spectrometer by single-stage acceleration in accordance with the present invention.

FIG. 15 is a schematic drawing that shows an example of a linear-type time-of-flight mass spectrometer by two-stage acceleration in accordance with the present invention.

FIG. 16 is a schematic drawing that shows an example of a reflector-type time-of-flight mass spectrometer in accordance with the present invention.

FIG. 17 is a drawing that shows an example of forming an opening in the central portion of the accelerating electrode in the present invention, providing a sample holding base that holds a sample particle on the back side thereof, and discharging the ionized particle.

FIG. 18 is an explanatory drawing that shows another embodiment of the accelerating portion in the time-of-flight mass spectrometer in accordance with the present invention.

FIG. 19 is a drawing that shows an example of the calculation result of the electric field and ion trajectory of the accelerating portion in the time-of-flight mass spectrometer of the present invention.

FIG. 20 is an explanatory drawing that shows an example of the calculation result of the electric field and ion trajectory of the accelerating portion in a conventional time-of-flight mass spectrometer.

FIG. 21 is a drawing that shows the result of performing an analysis test on a metal cluster beam by producing a mass spectrometer with a total length of 50 cm in order to confirm the operation and effect of the present invention.

### DESCRIPTION OF REFERENCE NUMERALS

1 neutral particle or ion
2 repeller electrode
2a inner surface
2b front end portion
2c hollow disc-shaped electrode
3 extractor electrode
4 mesh structure
5 introduction path
6 acceleration start position
7 power source
8 equipotential surface
9 introduction of a neutral particle or ion
11 neutral particle or ion that is introduced
12 repeller electrode
13 intermediate electrode
14 ground electrode
15 lens system
16 detector
17 extractor electrode
18 reflector
19, 20 ion
21 trajectory curve of an ion having an introduction energy of 0 eV
22 trajectory curve of an ion having an introduction energy of 10 eV
23 trajectory curve of an ion having an introduction energy of 20 eV
24 trajectory curve of an ion having an introduction energy of 30 eV
25 trajectory curve of an ion having an introduction energy of 40 eV
26 trajectory curve of an ion having an introduction energy of 50 eV
27 trajectory curve of an ion having an introduction energy of 100 eV
28 trajectory curve of an ion having an introduction energy of 150 eV
29 trajectory curve of an ion having an introduction energy of 200 eV
31 two-stage quadrupole lens

### BEST MODE FOR CARRYING OUT THE INVENTION

In order to realize both functions of the conventional accelerating portion and ion lens system with only a repeller electrode and an extractor electrode, the present invention includes an accelerating portion being constituted from a repeller electrode and an extractor electrode with a hole, with the inner surface on the extractor electrode side of the repeller electrode having a curved shape, in which the accelerating portion converges a distribution of times of flight accompanying deviations in the acceleration start position of ions and performs trajectory control by correcting a distribution of the introduction energy of ions.

### FIRST EMBODIMENT

Hereinbelow, an embodiment of the present invention is described with reference to the drawings, but the present invention is not limited thereto. Also, in order to simplify the description, a case is described in which a neutral particle that is introduced from outside of the accelerating portion being ionized by a laser into a monovalent cation, but that is introduced may also be an ion.

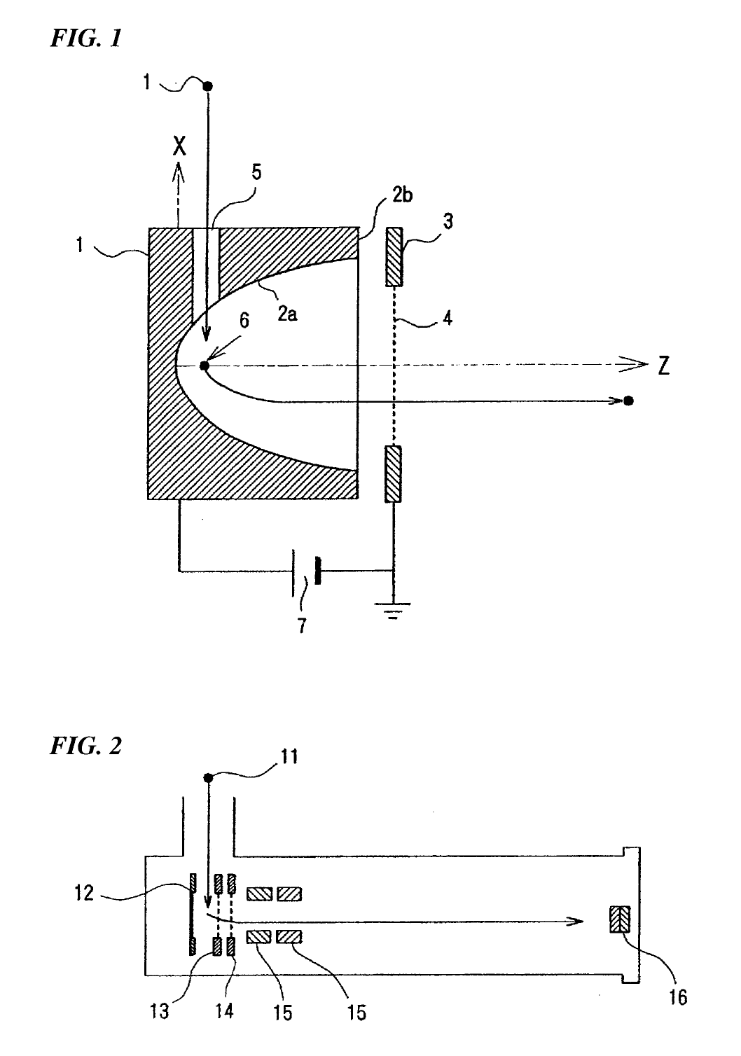

FIG. 1 is a drawing showing an example of the accelerating portion in the time-of-flight mass spectrometer of the present invention. Here, the direction of introducing a neutral particle 1, which is the object of measurement, is the X axis. The neutral particle 1 is ionized by a laser at an acceleration start position 6, and the resulting ion 1 is accelerated in a Z-axis direction that is perpendicular to the X axis by a repeller electrode 2 shown in a vertical cross-sectional view. The Y axis is a direction perpendicular to both the X axis and the Z axis. An extractor electrode 3 is preferably a flat plate having a hole in the center or a plate structure including a mesh structure. FIG. 1 shows a parallel flat plate having a mesh structure 4. The extractor electrode with a hole can be a flat plate with a hole in the center that is circular, elliptical or oval, or polygonal such as rectangular, with a hole that is elliptical, oval, or rectangular having its long axis along the X-axis direction.

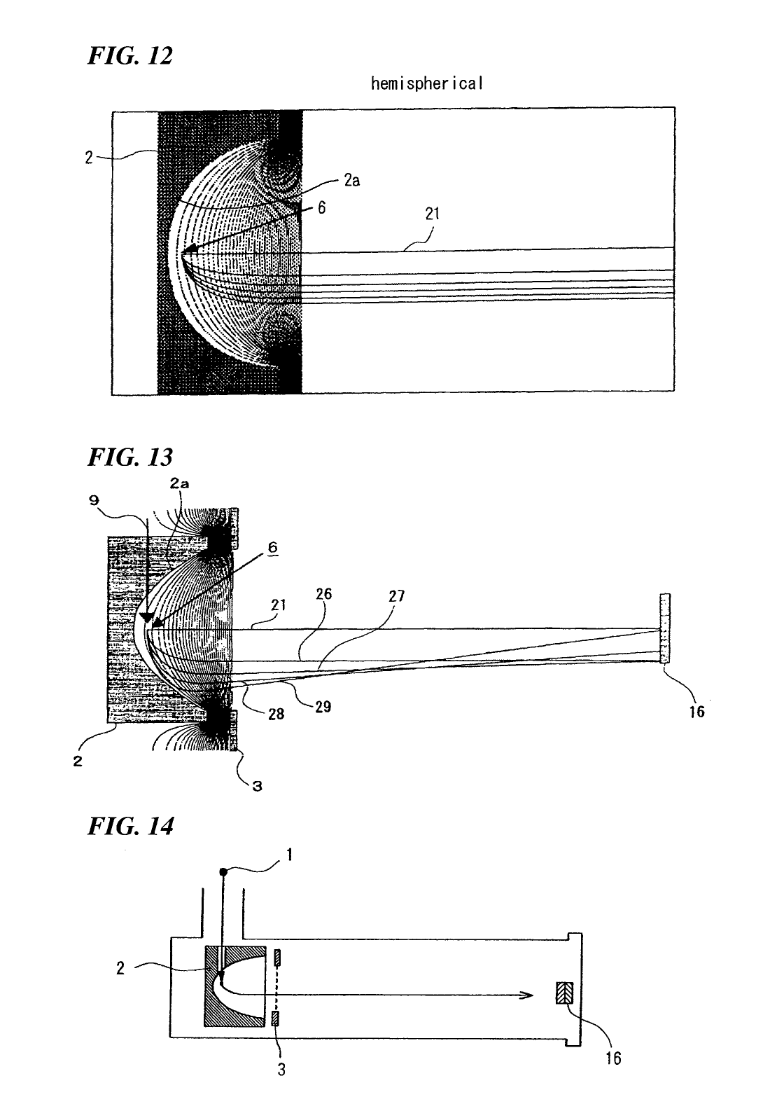

In the shape of the repeller electrode, an inner surface 2a of the portion facing the extractor electrode has a curved shape, with FIG. 1 showing a paraboloid shape that satisfies the equation z=A(x²+y²). Note that, here, A is a given parameter. In the present invention, A is preferably set to a value so that the inner diameter of a front end portion 2b of the repeller electrode has dimensions comparable to the diameter and length of the detection surface of the detector. Also, in the shape of the repeller electrode, the shape of the portion that does not face the extractor electrode side may be arbitrarily set, and in FIG. 1 is cylindrical. Note that regarding the curved shape of the repeller electrode, it has been confirmed that a similar effect is achieved even if formed, for example, in an approximate hyperboloid shape as shown in FIG. 11, or an approximate hemispherical shape as shown in FIG. 12, in addition to the paraboloid shape.

Since the neutral particle 1 that is the object of measurement is introduced from outside, an introduction path 5 required for the introduction is provided. The neutral particle 1 is introduced from the introduction path 5 to the acceleration start position 6.

One cause of a decrease in mass resolution in time-of-flight mass spectrometry is the distribution of the departure position of the ion (acceleration start position). For example, in the case of laser ionization, since the condensing diameter of the laser has a limit, the departure position of the ion (acceleration start position) is distributed. When the departure position of the ion (acceleration start position) is distributed, the flight speed of the ion is distributed due to the energy that the ion obtains from the electric field being distributed. Therefore, in time-of-flight mass spectrometry to determine the mass from the time of flight, the distribution of the departure position of ion (acceleration start position) becomes one cause of a reduction in the mass resolution. However, there is a method of correcting the distribution of this departure position (acceleration start position) to improve the mass resolution.

FIG. 4 is an outline drawing of the time-of-flight mass spectrometer that has a single-stage accelerating portion. The accelerating electrode is constituted from a repeller electrode with a potential of V1 and a ground electrode at ground potential. As shown in FIG. 4, ions of the same mass and same charge, in which an ion 19 (black circle) that departs from a position away from the extractor electrode and an ion 20 (white circle) that departs from a position near the extractor electrode, are considered. Compared to the ion 19 (black circle), the ion 20 (white circle) has less energy obtained from the electric field. Therefore, compared to the ion 19 (black circle), the ion 20 (white circle) has a slower speed after acceleration. However, compared to the ion 19 (black circle), since the ion 20 (white circle) departs from a position closer to the extractor electrode, it passes through the extractor electrode at an earlier time. Therefore, after passing through the extractor electrode, there is a position at which the ion 19 (black circle) catches up with and overtakes the ion 20 (white circle). This position is called space focus. By disposing the detector at this space focus position, differences in the acceleration start position are corrected, whereby it is possible to correctly measure the mass of an ion without lowering the mass resolution.

However, in the case of the time-of-flight mass spectrometer that has a single-stage accelerating portion as shown in FIG. 4, if the distance from the center of the distribution of acceleration start positions of ions to the extractor electrode is LA, the space focus position is located at the position L_{SF}=2L_{A} from the extractor electrode. In a time-of-flight mass spectrometer that measures mass from differences in time of flight, a flight distance of a certain length is required. As a result, in the case of disposing the detector at the position 2L_{A}, because the flight distance is too short it is not possible to accurately measure ion mass. A device for overcoming this is the Wiley-McLaren-type two-stage accelerating portion.

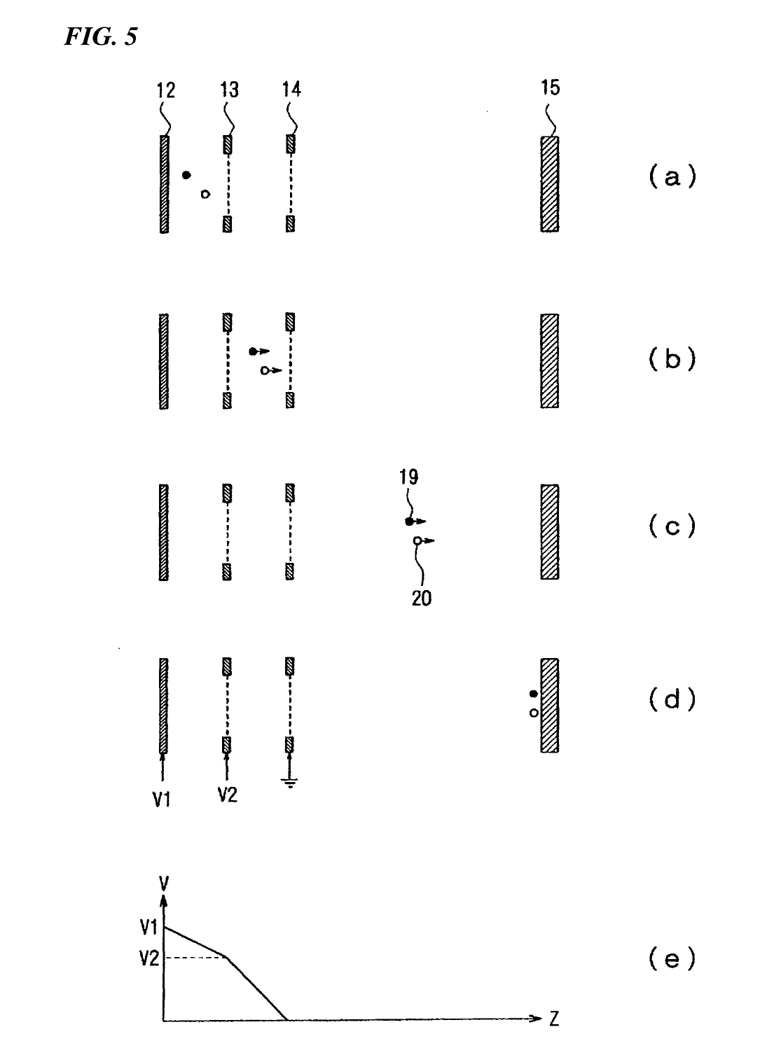

FIG. 5 is an outline view of a time-of-flight mass spectrometer that has a conventional Wiley-McLaren-type two-stage accelerating portion. Also, below the outline views (a) to (d) of FIG. 5, (e) of FIG. 5 is a graph that shows the potential distribution on the center axis (Z axis) with respect to (a) to (d) of FIG. 5. The accelerating electrode is constituted from the repeller electrode 12 of potential V1, an intermediate electrode 13 of potential V2, and a ground electrode 14 at ground potential. Two ions 19 and 20 with the same mass and charge but with different acceleration start positions are shown by a black circle and white circle, respectively. Also, the flight process of an ion is shown in the order of (a) to (d) of FIG. 5 from the acceleration start position (a) to the detector (d) of FIG. 5. By suitably selecting the arrangement interval of the accelerating electrode and the potentials V1 and V2, it is possible to position the space focus position at sufficiently distant, and so it becomes possible to make an ion fly for the flight distance required for mass separation. By disposing the detector at the space focus position located at sufficiently distant, the difference in time of flight of ions with different masses becomes greater, and also it is possible to make ions with the same mass and charge but with different acceleration start positions reach the detector at the same time. Since it is thus possible to obtain a high mass resolution, the Wiley-McLaren-type two-stage accelerating portion is often used as an accelerating portion in mass spectrometers.

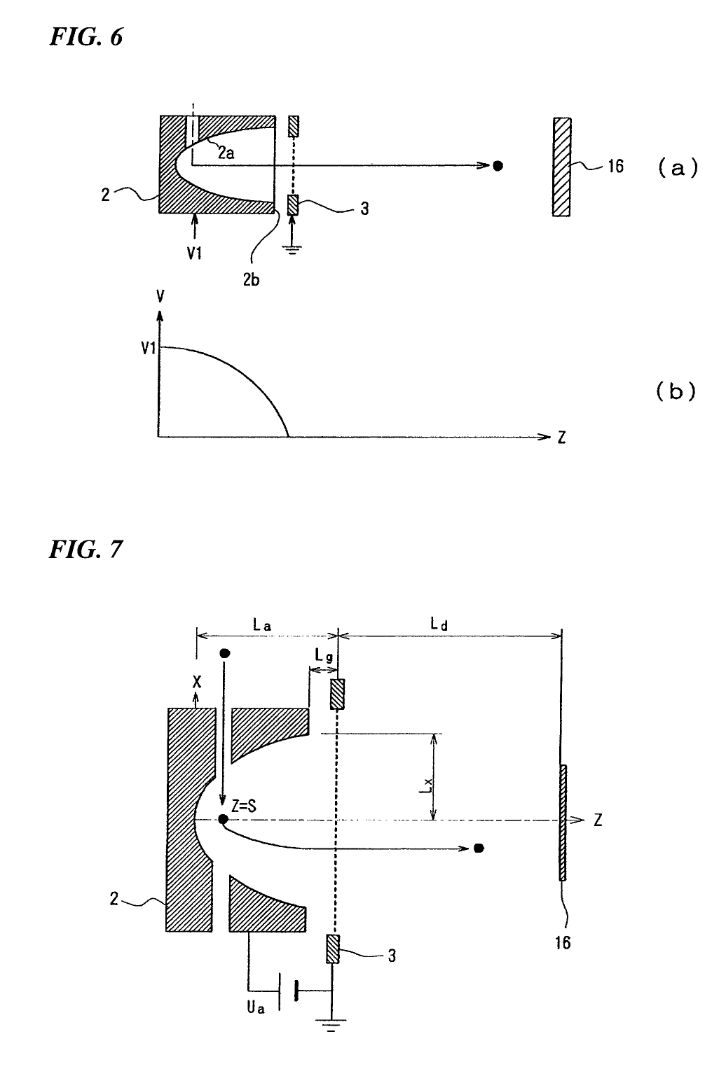

In contrast, (a) and (b) of FIG. 6 are explanatory drawings showing the embodiment shown in FIG. 1, which is a conceptual diagram of a time-of-flight mass spectrometer provided with an accelerating portion being constituted from the repeller electrode 2 of a potential V1 and the extractor electrode 3, and a detector 16. (b) of FIG. 6 below is a graph that shows the potential distribution on the Z axis in the accelerating electrode corresponding to (a) of FIG. 6. This potential distribution is a distribution that approximates the Wiley-McLaren-type two-stage accelerating portion shown in (e) of FIG. 5. By choosing the center of the distribution of acceleration start positions and the detector position, it is possible to make ions with different acceleration start positions reach the detector simultaneously. Also, from the electrode distribution, the space focus position is known to be sufficiently distant. By appropriately selecting the shape of the repeller electrode, the arrangement interval of the repeller electrode and the extractor electrode, and the center of the distribution of acceleration start positions, it is possible to arrange the space focus position far off.

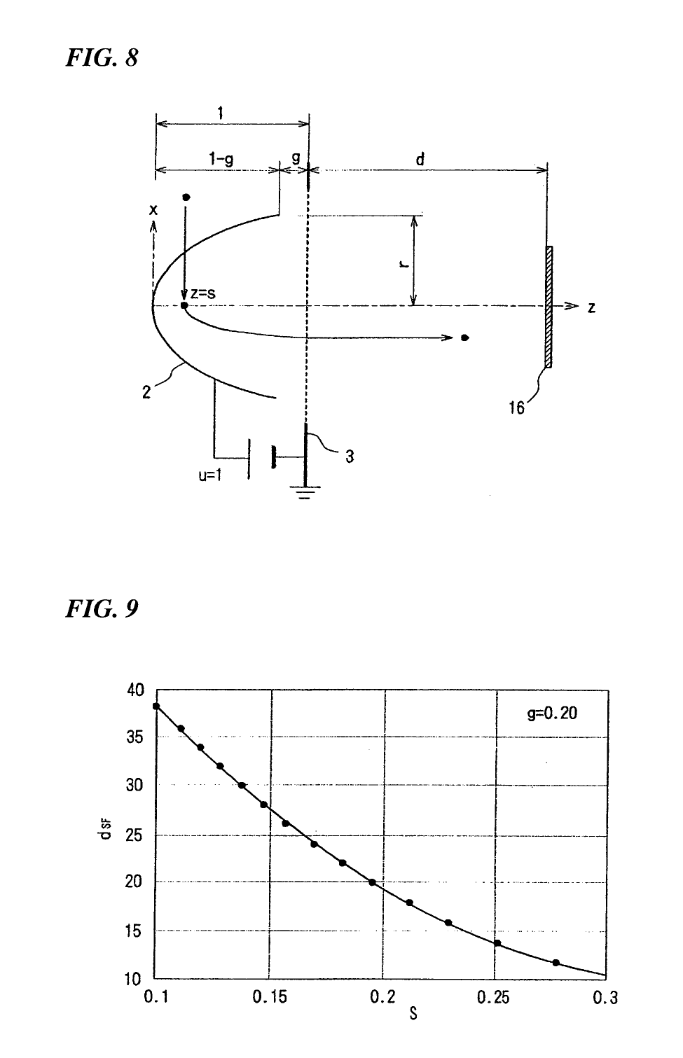

FIG. 7 is a drawing showing the device dimensions and voltage for the case of the shape of the inner surface of the repeller electrode being a paraboloid. FIG. 8 is a drawing that presents the device dimensions and voltage in standardized form. The space focus position is dependent on the arrangement interval g of the repeller electrode and the extractor electrode in FIG. 8, the radius r of the discharge end of the repeller electrode, and the acceleration start position s.

FIG. 9 shows the relationship between the acceleration start position s and the space focus position d_{SF} for the case of g=0.2 and r=0.8 obtained by simulation in the case shown in FIG. 8. If the acceleration start position s is 0.2, the space focus position d_{SF} becomes 19. In the device shown in FIG. 7, given an electrode of a size La=25 mm, Lr=20 mm, Lg=5 mm, the space focus position becomes 475 mm. Thus, the space focus position can be located sufficiently distant similarly to the Wiley-McLaren-type two-stage accelerating portion. If the detector is located at Ld=475 mm, the difference in the time of flight between ions with different masses increases, and ions with the same mass and charge but with different acceleration start positions can be made to reach the detector simultaneously. Thus, it is possible to obtain a high mass resolution.

Similarly, the space focus position can be positioned sufficiently distant in the case of the hyperboloid shape shown in FIG. 11 and the hemispherical shape shown in FIG. 12.

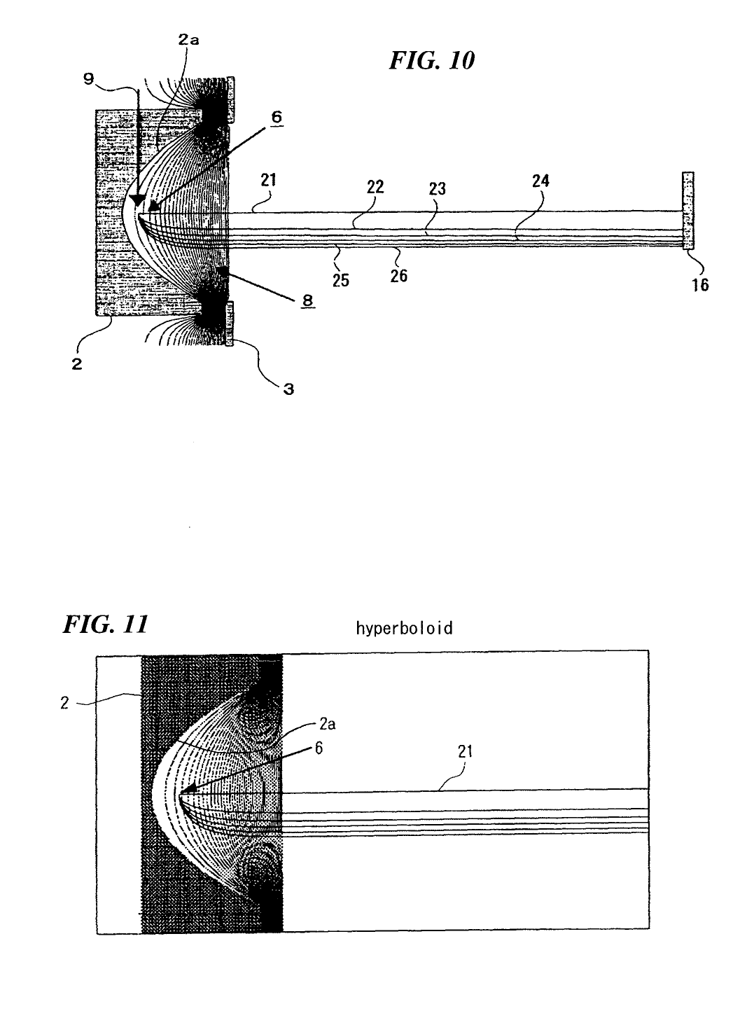

FIG. 10 is a drawing that shows an example of the calculation result of the electric field and the ion trajectory of the accelerating portion in the time-of-flight mass spectrometer in accordance with the present invention. FIG. 10 shows the calculation result of the electric field in the case of the repeller electrode 2 having a potential of 1,048 V. Here, since the inner surface 2a of the repeller electrode 2 is a paraboloidal surface, an electric field gradient and position distribution in the direction thereof are generated reflecting the paraboloidal surface. Here, in FIG. 10, 8 denotes equipotential lines of the electric field. The potential of the ion acceleration start position 6 is 1,000 V. A monovalent ion is accelerated by the electric field from here. Also, the potential of the extractor electrode 3 is 0 V.

FIG. 10 shows trajectory curves for ions having an introduction energy of 0 to 50 eV. Reference numeral 21 denotes the trajectory of 0 eV, 22 the trajectory of 10 eV, 23 the trajectory of 20 eV, 24 the trajectory of 30 eV, 25 the trajectory of 40 eV, and 26 the trajectory of 50 eV. An ion is not only accelerated by the electric field, but its trajectory is also corrected by the gradient of the electric field and the distribution of directions. An ion with zero introduction energy is accelerated only in the Z-axis direction from the acceleration start position 6 to the extractor electrode 3, and the trajectory proceeds along the Z axis.

Ions whose introduction energy is not zero are accelerated in the Z-axis direction at the acceleration start position 6. However, the initial trajectory proceeds to the lower right in FIG. 10. Subsequently, these ions continue to be accelerated to the upper right in FIG. 10 until the extractor electrode 3, and thereby the trajectory from the extractor electrode onward is controlled to be nearly parallel with the Z axis.

In this embodiment, by controlling the trajectory of ions having introduction energy of up to 50 eV, it is possible to guide the trajectory from the accelerating portion onward to be nearly parallel with the Z axis. That is, for an ion possessing introduction energy that is approximately 5% or less with respect to the acceleration energy, by controlling the ion trajectory it is possible to guide the trajectory from the accelerating portion onward to be nearly parallel with the Z axis until the detector 16. This characteristic was conventionally realized by the combination of an accelerating portion and quadrupole lens, but in the present invention, it can be achieved by a pair of electrodes. Note that in FIG. 10, reference numeral 9 shows the introduction of a neutral particle or ion.

Even in the case of using an accelerating electrode whose inner surface has a hyperboloid shape, similar trajectory curves are obtained due to the same electric field distribution as shown in FIG. 11. Also, for an accelerating electrode whose inner surface has a hemispherical shape, similar trajectory curves are obtained due to the same electrode distribution as shown in FIG. 12.

Note that it is impossible to make the trajectory of ions having introduction energy that is 5% or more with respect to the acceleration energy become nearly parallel with the Z axis, but it is possible to guide them to the detection surface of the detector. This example is shown in FIG. 13. In this case, the ion acceleration start position that enables the most efficient control of an ion is determined depending on the position and detectable surface area of the detector.

FIG. 13 shows the trajectory of an ion with introduction energy of 0 to 200 eV when the potential of the ion acceleration start position is 1,000 V. In FIG. 13, reference numeral 27 denotes the trajectory of an ion having an introduction energy of 100 eV, 28 the trajectory of an ion having an introduction energy of 150 eV, and 29 the trajectory of an ion having an introduction energy of 200 eV respectively. Note that explanations of those reference numerals having the same meaning as those in FIG. 10 are omitted.

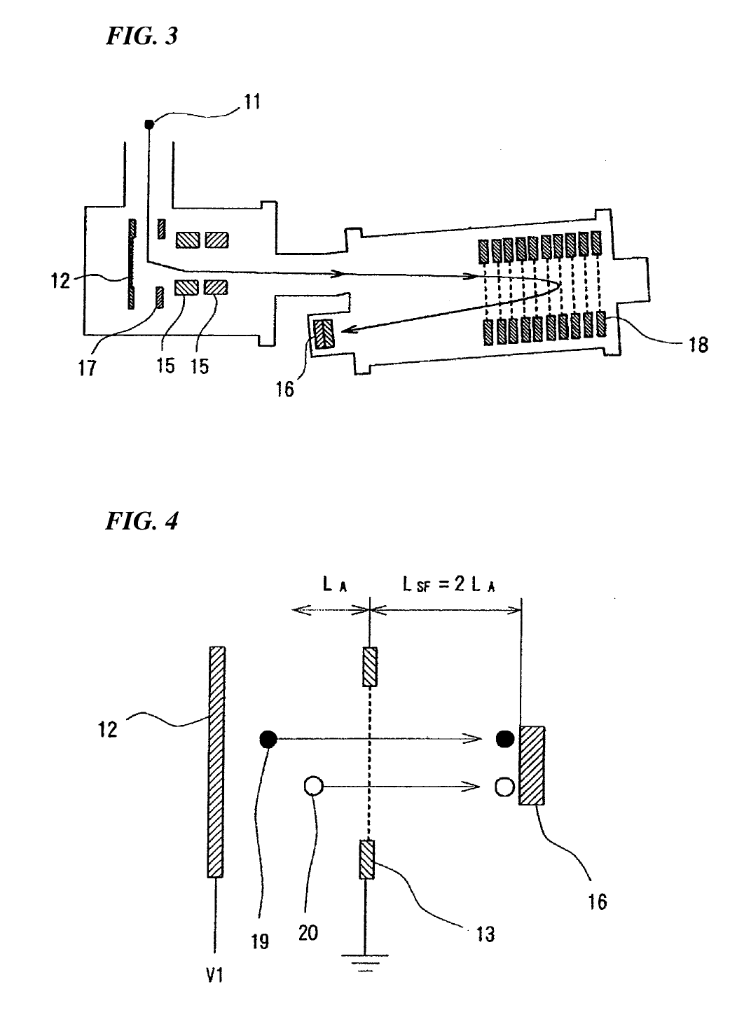

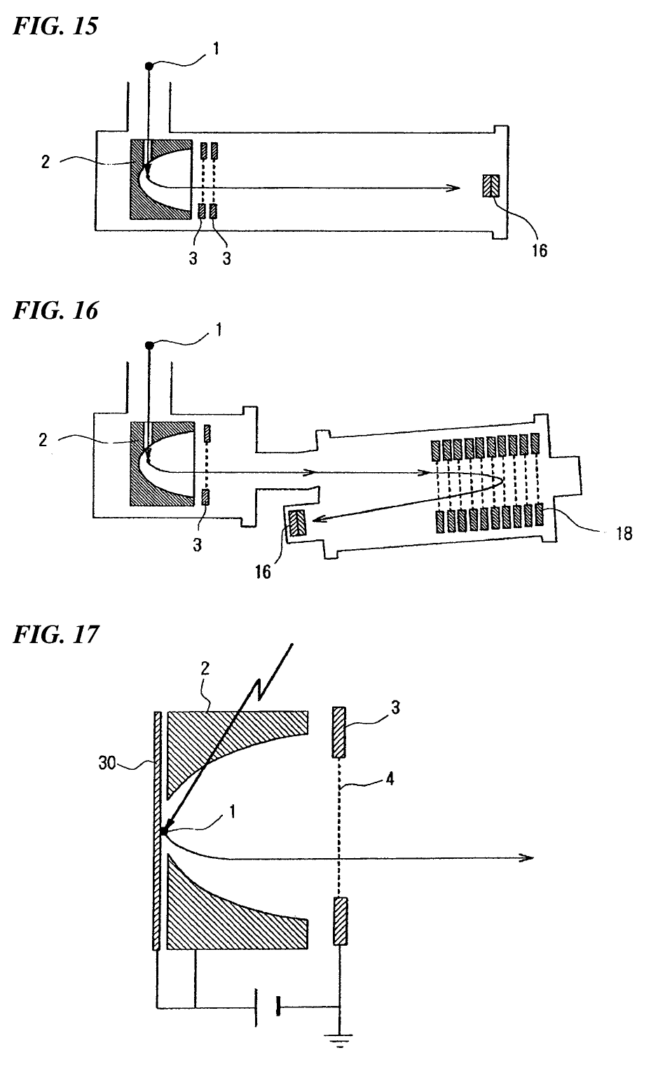

FIGS. 14 to 16 are conceptual drawings showing cross sections of examples of the time-of-flight mass spectrometer of the present invention. FIG. 14 shows a time-of-flight mass spectrometer with linear, single-stage acceleration, FIG. 15 shows a time-of-flight mass spectrometer with linear, two-stage acceleration, and FIG. 16 shows a reflector-type time-of-flight mass spectrometer. The reference numerals in FIGS. 14 to 16 are the same as those of FIGS. 2 and 4. In the conventional time-of-flight mass spectrometer shown in FIGS. 2 and 3 described above, many electrodes are required for the accelerating portion and the ion optical system. In contrast, in the present invention, it is possible to make a particle or ion 1 fly to the detector 16 with only a pair of electrodes of the repeller electrode 2 and the extractor electrode 3 instead of the accelerating portion and the ion optical system. Also, in the time-of-flight mass spectrometer of the present invention, it is possible to use members of any conventional time-of-flight mass spectrometer for members other than the acceleration and the ion optical system.

Also, in the aforedescribed embodiment, in the shape of the repeller electrode, the shape of the portion facing the extractor electrode side was made to be a paraboloid shape that satisfies the equation z=A(x²+y²). However, even if this portion is changed to a curve that approximates a paraboloid shape the same effect is obtained, and moreover the same is true for a hyperboloid shape and a hemispherical shape. Such modifications may be appropriately made by the manufacturer.

The accelerating portion of the present invention can position the space focus position at a sufficient distance and has a lens action that can guide an ion to a detector by controlling the trajectory even when there is a distribution in the energy introduced to the accelerating portion. Also, in order to obtain a high mass resolution by correcting the departure position of ions, that is, the distribution of acceleration start positions, the detector is arranged at the space focus position.

The aforesaid embodiment illustrated the example of introducing neutral particles or ions from outside to an accelerating electrode. However, besides that, as shown for example in FIG. 17, it is possible to form an opening in the center portion of the accelerating electrode 2, provide a sample holding base 30 on the back side, and apply the same potential to this sample holding base 30 as the accelerating electrode. By applying laser irradiation or the like on a particle that is placed on this sample holding base 30 at a position facing the opening of the accelerating electrode 2, it can be extracted as an ion and analyzed.

### SECOND EMBODIMENT

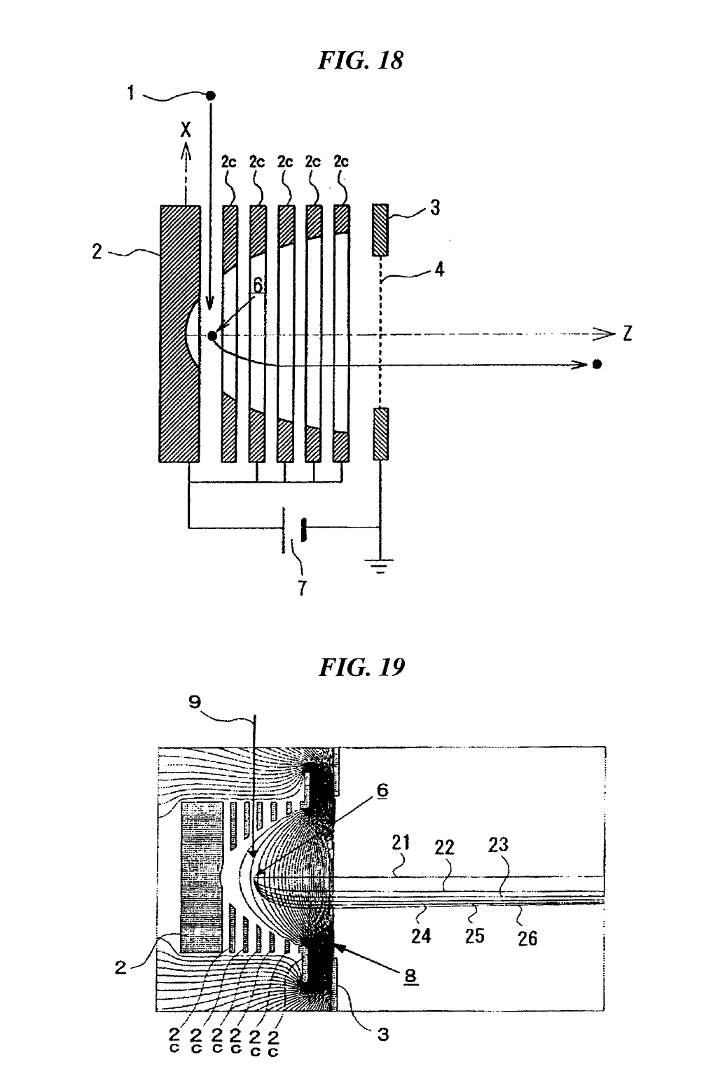

As another embodiment of the present invention, an equivalent effect as the aforedescribed embodiment is obtainable with a repeller electrode that is constituted by a plurality of electrodes instead of being formed by one piece, and making an equipotential surface in the vicinity of the electrode substantially a paraboloid shape. In this embodiment, a drawing explaining an example of the accelerating portion is shown in FIG. 18, and the calculation result of the electric field and the ion trajectory of the accelerating portion are shown in FIG. 19.

FIG. 18 is a vertical cross-sectional view of the accelerator portion similar to FIG. 1. The front end portion of the repeller electrode is constituted by a plurality of hollow disc-shaped electrodes 2c. Also, the other reference numerals denote portions identical to those shown in FIG. 1. Here, applying a voltage from a power source 7 to the repeller electrode 2 generates an electric field between the repeller electrode 2 and the extractor electrode 3 that accelerates the ion 1.

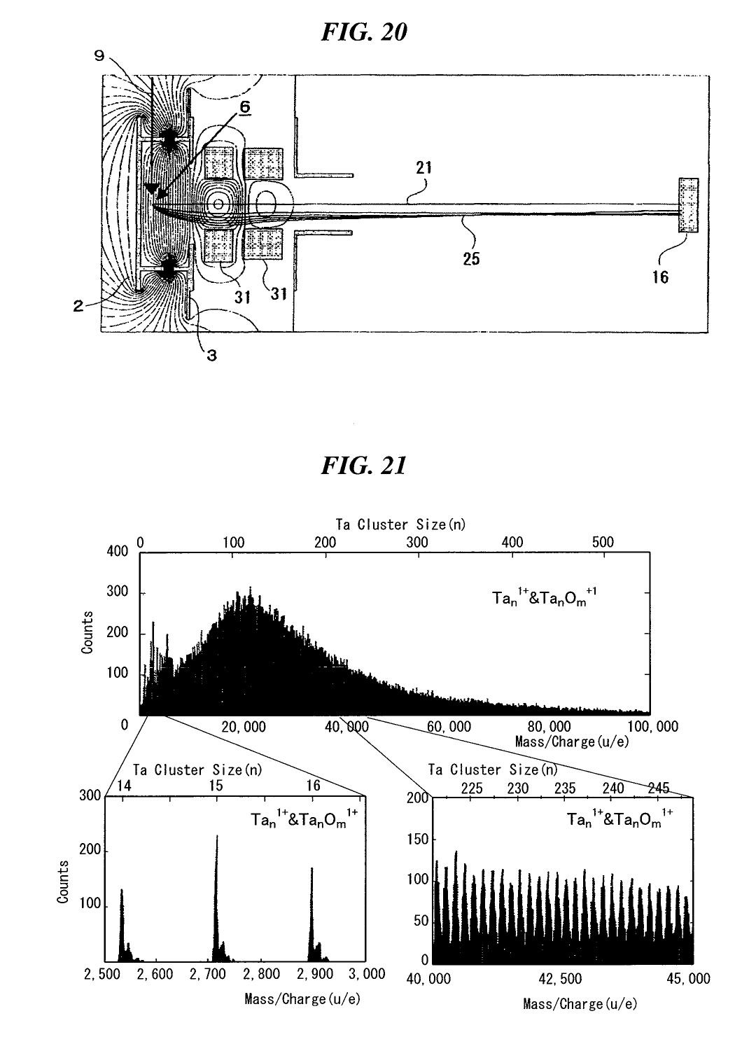

FIG. 19 shows the calculation result of the electric field in the case of the repeller electrode 2 constituted from a plurality of electrodes shown in cross-section having a potential of 1,048 V, the ion acceleration start position 6 having a potential of 1,000 V, and the extractor electrode 3 having a potential of 0 V. Also, the reference numerals in FIG. 19 are the same as those shown in FIG. 4. Also, in the embodiment shown in FIG. 19, the equipotential lines that show the equipotential surface 8 in the vicinity of the repeller electrode have a paraboloid shape. Even in this case, it is possible to trace a similar trajectory as an ion in the ion optical system that uses a conventional accelerator portion and two-stage quadrupole lens 31 shown in FIG. 20. Note that among the reference numerals in FIG. 12, descriptions of those identical to those in FIG. 10 are omitted.

In the case of constituting the repeller electrode from a plurality of electrodes, there is no particular limitation on the number of electrodes that constitute the repeller electrode, however, it is preferably constituted with two electrodes disposed partitioning off the ion introduction path.

Moreover, the method of dividing the accelerating electrode as above is similar also for the case of the accelerating electrode being a hyperboloid shape or a hemispherical shape.

In order to confirm the operation and effect of the present invention, a mass spectrometer with a total length of 50 cm was produced by way of trial, with the result of performing a metal cluster beam spectrometry test shown in FIG. 21. The diagram shows that mass spectrometry could be performed with a suitably high mass resolution (approximately 1,200 defined by half-value width) and over a wide mass range (1 to 100,000 u/e). Here, u is an electron mass unit, and e is an elementary electric charge.

1. A time-of-flight mass spectrometer comprising an accelerating portion that includes a repeller electrode and an extractor electrode with a hole, wherein
an inner surface on the extractor electrode side of the repeller electrode has a curved shape, and
the accelerating portion converges a distribution of time of flight accompanying deviations in the acceleration start position of ions and also performs trajectory control by correcting a distribution of the introduction energy of ions.

2. The time-of-flight mass spectrometer in accordance with claim 1, wherein the curved shape of the repeller electrode is approximately paraboloid shape.

3. The time-of-flight mass spectrometer in accordance with claim 1, wherein the curved shape of the repeller electrode is approximately hyperboloid shape.

4. The time-of-flight mass spectrometer in accordance with claim 1, wherein the curved shape of the repeller electrode is approximately hemispherical shape.

5. A time-of-flight mass spectrometer comprising an accelerating portion that includes a repeller electrode and an extractor electrode with a hole, wherein
the repeller electrode is constituted by a plurality of electrodes, and an equipotential surface in the vicinity of the repeller electrode has a curved shape, and
the accelerating portion converges a distribution of times of flight accompanying deviations in the acceleration start position of ions and also performs trajectory control by correcting a distribution of the introduction energy of ions.

6. The time-of-flight mass spectrometer in accordance with claim 5, wherein the curved shape of the equipotential surface of the repeller electrode is approximatelyparaboloid shape.

7. The time-of-flight mass spectrometer in accordance with claim 5, wherein the curved shape of the equipotential surface of the repeller electrode is approximately hyperboloid shape.

8. The time-of-flight mass spectrometer in accordance with claim 5, wherein the curved shape of the equipotential surface of the repeller electrode is approximately hemispherical shape.

9. The time-of-flight mass spectrometer in accordance with any one of claims 1 through 8, wherein the extractor electrode with a hole is a flat plate with a circular hole formed in the center.

10. The time-of-flight mass spectrometer in accordance with claim 1, wherein the extractor electrode with a hole is a flat plate with an elliptical or oval hole formed in the center.

11. The time-of-flight mass spectrometer in accordance with any one of claims 1 through 8, wherein the extractor electrode with a hole is a flat plate with a polygonal hole formed in the center.

12. The time-of-flight mass spectrometer in accordance with claim 11, wherein the polygonal hole is rectangular.

13. The time-of-flight mass spectrometer in accordance with any one of claims 1 through 8, wherein the extractor electrode with a hole is a mesh structure.

14. The time-of-flight mass spectrometer in accordance with any one of claims 1 through 8, wherein a plurality of the extractor electrodes is provided.

15. The time-of-flight mass spectrometer in accordance with any one of claims 1 through 8, wherein an opening is formed in the center of the repeller electrode on the side opposite the side at which the extractor electrode is arranged, a sample holding base is arranged facing the opening; and
discharging a particle that is held in the sample holding base by ionization via laser irradiation, atomic beam irradiation, ion irradiation, and the like.

16. The time-of-flight mass spectrometer in accordance with any one of claims 1 through 8, wherein an ion discharged from the extractor electrode is guided to a detector by reflecting with a reflector.

17. The time-of-flight mass spectrometer in accordance with claim 2, wherein a particle or ion to be introduced to the repeller electrode, which is constituted by a plurality of electrodes, is introduced to the repeller electrode from a gap between the separated electrodes.
